(19) United States
(12) Patent Application Publication
(10) Pub. No.: US 2024/0257230 A1
(43) Pub. Date: Aug. 1, 2024

(54) ARTIFICIAL INTELLIGENCE AND MACHINE LEARNING-BASED OVERSEAS PUBLIC PROCUREMENT CUSTOMIZED BIDDING INFORMATION PROVISION SERVICE SYSTEM AND METHOD

(71) Applicants: Man-Ki KIM, Seoul (KR); Global Procurement Development Institute, Goyang-si (KR)

(72) Inventor: Man-Ki KIM, Seoul (KR)

(73) Assignees: Man-Ki KIM, Seoul (KR); Global Procurement Development Institute, Goyang-si (KR)

(21) Appl. No.: 18/628,898

(22) Filed: Apr. 8, 2024

Related U.S. Application Data
(63) Continuation of application No. PCT/KR2022/014338, filed on Sep. 26, 2022.

(30) Foreign Application Priority Data
Oct. 6, 2021 (KR) 10-2021-0132653

(51) Int. Cl. G06Q 30/08; G06Q 50/26

(52) U.S. Cl. CPC G06Q 30/08; G06Q 50/26

(57) ABSTRACT

Disclosed are an artificial intelligence and machine learning-based overseas public procurement customized bidding information provision service system and method. The disclosure can provide optimal bidding information suitable for a corresponding company by matching company information, in which domestic companies meet international bidding requirements, and bidding information, which is collected from procurement information of overseas procurement owners, by using an AI-based suitability analysis model.

### CROSS-REFERENCE TO RELATED APPLICATION

Pursuant to 35 USC 120 and 365 (c), this application is a continuation of International Application No. PCT/KR2022/014338 filed on Sep. 26, 2022, and claims the benefit under 35 USC 119 (a) of Korean Application No. 10-2021-0132653 filed on Oct. 6, 2021, in the Korean Intellectual Property Office, the entire disclosure of which is incorporated herein by reference for all purposes.

### TECHNICAL FIELD

The disclosure relates to an artificial intelligence and machine learning-based overseas public procurement customized bidding information provision service system and method and, more particularly, to an artificial intelligence and machine learning-based overseas public procurement customized bidding information provision service system and method for providing optimal bidding information suitable for a company by matching company information, which in domestic companies meet international bidding requirements, and bidding information, which is collected from procurement information by overseas procurement buyers, by using an artificial intelligence-based suitability analysis model.

### BACKGROUND ART

Public procurement refers to the purchase by government departments or public institutions of goods, services, and work for the public interest with public funds according to procurement regulations.

Public procurement markets are a core economic activity area of ‘Strategic Sustainable Public Procurement (SSPP, strategically supporting technical innovation, realization of social values, and sustainability by strategically using the public procurement budget, which accounts for approximately 15% of gross domestic product (GDP) mainly in major advanced OECD countries)’ that supports policies of international organizations and national governments.

Companies to participate in public procurement essentially need to check and analytically examine products offered in advance.

Further, the companies need to conduct a large number of tasks, such as direct confirmation of production certification, product registration, a contract of Multiple Award Schedule (MAS), and various registrations related to public procurement, according to the examination result.

In addition, regarding the products offered, the companies need to recognize an irrelevant registration task or a procedure for registering essential requirements in order in advance and appropriately deal with the same, and a patent, performance certification, or NET, NEP, or GS certification may be added as an optional requirement.

The international public procurement market including international organizations, such as the UN, and multilateral development banks, such as the World Bank and the Asian Development Bank, forms a public procurement market with a size of approximately six trillion dollars. In particular, the size of public procurement ordered by the UN is valued at more than 22 trillion won per year.

However, companies of South Korea have a very low market share in the international public procurement market.

As of 2020, the amount of orders received by South Korean companies in the UN procurement market is approximately $160 million, accounting for approximately 1.3% of the UN procurement market, which is very low.

The main reasons for this low market share are that it is difficult to obtain bid notices announced in English from various buyers, such as the UN, the UNICEF, the World Bank, the Asian Development Bank, the US government, and the EU in overseas public procurement markets, compared to the domestic public procurement market, and a notice suitable for each company fails to be selected from among a large number of bid notices posted every day.

In addition, the main reasons include a lack of competency of executives and overseas business managers of companies, a shortage of professional labor to investigate and analyze a request for proposal (RFP) and to make a proposal document for the process of international bidding-related projects, and a shortage of human resources and experience related to bidding.

### DISCLOSURE OF INVENTION

### Technical Problem

To solve the foregoing problems, an aspect of the disclosure is to provide an artificial intelligence and machine learning-based overseas public procurement customized bidding information provision service system and method for providing optimal bidding information suitable for a company by matching company information, in which domestic companies meet international bidding requirements, and bidding information, which is collected from procurement information by overseas procurement buyers, by using an artificial intelligence and machine learning-based suitability analysis model.

### Solution to Problem

To achieve the foregoing aspect, an artificial intelligence and machine learning-based overseas public procurement customized bidding information provision service system according to an embodiment of the disclosure includes a suitability analysis server that extracts one or more bid notices suitable for a company by comparing profile information by company that meets an international bidding requirement stored in a bidding company database with meta information of a bid notice by buyer stored in a bid notice database by using an artificial intelligence-based suitability analysis model, matches the one or more bid notices with the company, evaluates matching suitability based on common information between the profile information and the meta information, and extracts an optimal bid notice suitable for the company.

The suitability analysis server according to the embodiment includes a company information management unit that manages company analysis information, product analysis information, financial analysis information, bidding environment information, and company capability information about each company provided from the company, a bid notice management unit that receives bid notice information by connecting to one or more buyer terminals and manages the bid notice information by buyer by dividing the received bid notice information into general terms and conditions, special terms and conditions, and specifications, and a suitability analysis unit that analyzes and evaluates the matching suitability for a bidding condition required by the buyer by mapping one or more company keywords extracted from the profile information by using the artificial intelligence-based suitability analysis model onto one or more words or sentences retrieved from the bid notice by buyer corresponding to the company keywords, extracts the optimal bid notice suitable for the company, based on the calculated value of the evaluated matching suitability, and transmits the extracted bid notice to company terminals by matching the extracted bid notice to the company.

The suitability analysis server according to the embodiment extracts the bid notice suitable for the company, based on the matching suitability based on the common information between the profile information and the meta information by mapping the profile information by company to the meta information of the bid notice collected by the bid notice management unit.

The suitability analysis server according to the embodiment transmits the one or more extracted bid notices, along with numerical information, to the company terminals.

The suitability analysis server according to the embodiment includes a learning agent, and the learning agent is trained to determine optimal interpretation and intention information for a word or sentence used by the artificial intelligence-based suitability analysis model for each buyer.

The calculated value of the matching suitability according to the embodiment is calculated by the following equation: E=x(y1+y2+y3), where E is the calculated value of the matching suitability; x is an evaluation item of a purchasing organization, which is a constant; as values for a quantified item-specific requirement of the purchasing organization with respect to the company, which are variables, y1 is a standardized value for the requirement of the general terms and conditions of the buyer, y2 is a standardized value for the requirement of the special terms and conditions of the buyer, and y3 is a standardized value for the requirement of the technical specifications of the buyer.

The bidding company database according to the embodiment stores the profile information including one or more of company analysis information, product analysis information, financial analysis information, bidding environment information, and company capability information about each company.

The bid notice database according to the embodiment stores the bid notice by buyer and the meta information including a bidding condition based on the bid notice.

The artificial intelligence-based suitability analysis model according to the embodiment evaluates the matching suitability, based on a requirement of minimum eligibility and qualification criteria included in the bid notice.

The artificial intelligence-based suitability analysis model according to the embodiment evaluates the matching suitability, based on technical and financial weights and a requirement of technical evaluation criteria included in the bid notice.

The artificial intelligence-based suitability analysis model according to the embodiment extracts ‘eligibility’ as a company keyword from the profile information by company that meets the international bidding requirement, extracts a sentence related to ‘eligibility’ from the requirements of the bid notice of the buyer, and extracts the common information between the company and the buyer by matching the related sentence extracted from the requirements with detailed condition information about the company related to the company keyword of ‘eligibility’.

An artificial intelligence and machine learning-based overseas public procurement customized bidding information provision service method according to an embodiment of the disclosure includes operation a) in which a suitability analysis server extracts one or more bid notices suitable for a company by comparing profile information by company that meets an international bidding requirement stored in a bidding company database with meta information of a bid notice by buyer stored in a bid notice database by using an artificial intelligence-based suitability analysis model, matches the one or more bid notices with the company, evaluates matching suitability based on common between information the profile information and the meta information, and extracts an optimal bid notice suitable for the company, and operation b) in which the suitability analysis server transmits the extracted bid notices to company terminals by company.

The operation a) according to the embodiment includes operation a-1) in which the suitability analysis server extracts one or more company keywords from the profile information by using the artificial intelligence-based suitability analysis model, operation a-2) in which the suitability analysis server evaluates the matching suitability for a bidding condition required by the buyer by mapping one or more words or sentences retrieved from the bid notice by buyer onto the one or more extracted company keywords, and operation a-3) in which the suitability analysis server extracts the optimal bid notice suitable for the company, based on the calculated value of the evaluated matching suitability.

In the operation a-2) according to the embodiment, the suitability analysis server retrieves a used word or sentence by using a learning agent trained to determine optimal interpretation and intention information for each buyer.

The calculated value of the matching suitability according to the embodiment is calculated by the following equation: E=x (y1+y2+y3), where E is the calculated value of the matching suitability; x is an evaluation item of a purchasing organization, which is a constant; as values for a quantified item-specific requirement of the purchasing organization with respect to the company, which are variables, y1 is a standardized value for the requirement of the general terms and conditions of the buyer, y2 is a standardized value for the requirement of the special terms and conditions of the buyer, and y3 is a standardized value for the requirement of the technical specifications of the buyer.

The artificial intelligence and machine learning-based overseas public procurement customized bidding information provision service method according to an embodiment of the disclosure further includes operation a′) in which the suitability analysis server stores the profile information including one or more of company analysis information, product analysis information, financial analysis information, bidding environment information, and company capability information collected by company in the bidding company database.

The artificial intelligence and machine learning-based overseas public procurement customized bidding information provision service method according to an embodiment of the disclosure further includes operation a″) in which the suitability analysis server stores the bid notice including the meta information collected from one or more buyer terminals and the bid notice by buyer by dividing the bid notice into general terms and conditions, special terms and conditions, and specifications in the bid notice database.

The artificial intelligence-based suitability analysis model according to the embodiment evaluates the matching suitability, based on a requirement of minimum eligibility and qualification criteria included in the bid notice.

The artificial intelligence-based suitability analysis model according to the embodiment extracts ‘eligibility’ as a company keyword from the profile information by company that meets the international bidding requirement, extracts a sentence related to ‘eligibility’ from the requirements of the bid notice of the buyer, and extracts the common information between the company and the buyer by matching the related sentence extracted from the requirements with detailed condition information about the company related to the company keyword of ‘eligibility’.

### Advantageous Effects of Invention

According to the disclosure, it is possible to provide optimal bidding information suitable for a company, based on matching suitability obtained by evaluating profile information by company, in which domestic companies meet an international bidding requirement, and bidding information including meta information collected from procurement information by an overseas procurement buyer, by using an artificial intelligence-based suitability analysis model, thereby increasing overseas procurement participation of the company in a public procurement project of an overseas ordering organization and the overseas procurement success rate of the company.

According to the disclosure, it is possible to provide each company with a bid notice including eligibility and suitability essential for overseas public procurement.

According to the disclosure, it is possible to provide a bid notice based on bid notices of various buyers and characteristics of separate companies, thereby increasing a bid success rate.

According to the disclosure, it is possible to identify requirements of international public procurement markets for an industry to which a company belongs or products, thus using the requirements for improvement in product functions to meet market demand.

### BRIEF DESCRIPTION OF DRAWINGS

FIG. 1 illustrates the configuration of an artificial intelligence and machine learning-based overseas public procurement customized bidding information provision service system according to an embodiment of the disclosure;

FIG. 2 is a block diagram illustrating a suitability analysis server of the artificial intelligence and machine learning-based overseas public procurement customized bidding information provision service system according to the embodiment of FIG. 1;

FIG. 3 is a flowchart illustrating an artificial intelligence and machine learning-based overseas public procurement customized bidding information provision service method according to an embodiment of the disclosure; and

FIG. 4 is a flowchart illustrating a suitability analysis process of the artificial intelligence and machine learning-based overseas public procurement customized bidding information provision service method according to the embodiment of FIG. 3.

### BEST MODE FOR CARRYING OUT THE INVENTION

Hereinafter, the disclosure will be described in detail with reference to exemplary embodiments and the accompanying drawings, in which like reference numerals will be understood to refer to like elements throughout the drawings.

Before describing specific details for implementing the disclosure, it should be noted that components not directly related to the technical gist of the disclosure are omitted without departing from the technical gist of the disclosure.

Terms or words used in this description and the claims should be interpreted as having meanings and concepts that are consistent with the technical idea of the disclosure on the basis of the principle that the inventor can define the concept of appropriate terms to explain the disclosure in the best way.

As used herein, the expression that a part “includes” an element does not mean exclusion of other elements but means that the part may further include other elements.

Terms “unit”, “-or/er”, “module”, and the like used herein indicate a unit for processing at least one function or operation, and may be configured as hardware, software, or a combination of hardware and software.

The term “at least one” is defined as a term including the singular and the plural, and even though the term “at least one” does not exist, it will be apparent that each component may exist in the singular or plural and may mean the singular or plural.

Each component being provided in the singular or plural form may be changed depending on the embodiments.

Hereinafter, exemplary embodiments of an artificial intelligence and machine learning-based overseas public procurement customized bidding information provision service system and method according to an embodiment of the disclosure will be described in detail with reference to the accompanying drawings.

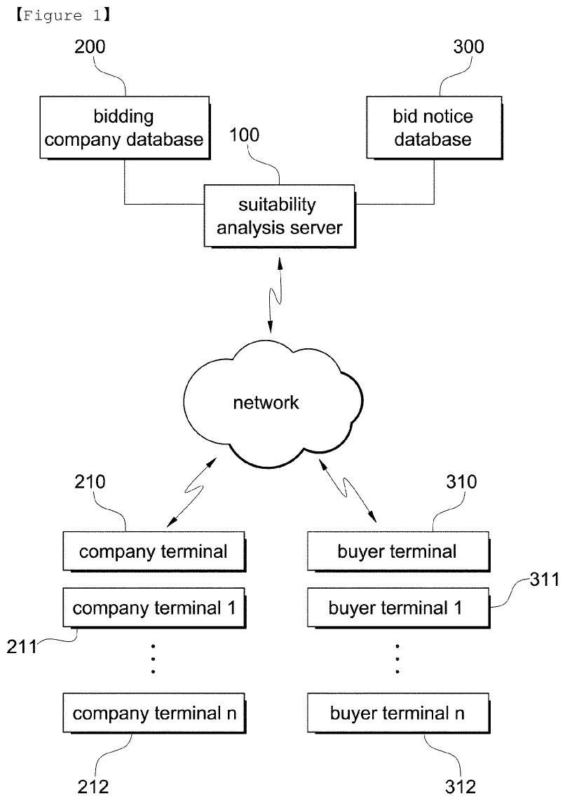

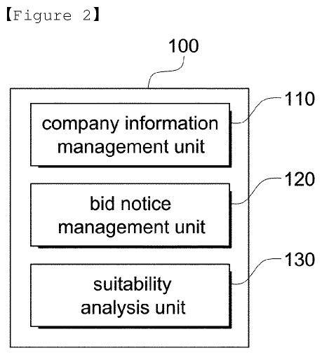

FIG. 1 illustrates the configuration of an artificial intelligence and machine learning-based overseas public procurement customized bidding information provision service system according to an embodiment of the disclosure, and FIG. 2 is a block diagram illustrating a suitability analysis server of the artificial intelligence and machine learning-based overseas public procurement customized bidding information provision service system according to the embodiment of FIG. 1

Referring to FIG. 1 and FIG. 2, the artificial intelligence and machine learning-based overseas public procurement customized bidding information provision service system according to the embodiment of the disclosure analyzes company information in which a domestic company meets an international bidding requirement and bidding information collected from procurement information about an overseas procurement buyer by using an artificial intelligence-based suitability analysis model.

In addition, the artificial intelligence and machine learning-based overseas public procurement customized bidding information provision service system according to the embodiment of the disclosure may extract and provide biding information the most suitable for a company by matching analyzed bidding information and profile information about the company.

To this end, the artificial intelligence and machine learning-based overseas public procurement customized bidding information provision service system according to the embodiment of the disclosure may include a suitability analysis server 100, a bidding company database 200, and a bid notice database 300.

The suitability analysis server 100 analyzes profile information about a company or profile information by company stored in the bidding company database 200 and a bid notice by buyer stored in the bid notice database 300 by using the artificial intelligence-based suitability analysis model.

The suitability analysis server 100 may extract one or more bid notices suitable for a company by comparing the profile information about the company, the bid notice, and meta information included in the bid notice.

The suitability analysis server 100 may extract an optimal bid notice suitable for a company by evaluating matching suitability based on common information between the profile information and the meta information.

Matching suitability refers to a value obtained by extracting common information between profile information about a company that meets an international bidding requirement and a bid notice by an overseas procurement buyer by matching the profile information about the company and a bidding condition or a requirement collected from the bid notice by the buyer, and numerically converting an evaluation result based on the extracted common information.

The suitability analysis server 100 may extract and provide a bid notice that is the most suitable for the profile information about the company, that is, a bid notice with the highest matching result value, based on the calculated value the of evaluated matching suitability.

To this end, the suitability analysis server 100 may include a company information management unit 110, a bid notice management unit 120, and a suitability analysis unit 130.

The company information management unit 110 analyzes and manages profile information provided by a company. The profile information may be, for example, company evaluation information including company analysis information, product analysis information, financial analysis information, bidding environment information, and company capability information.

That is, the company information management unit 110 receives the profile information about the company related to company information, product information, certifications, environmental certification, ESG compliance, production capability, human resources management (HRM), past performance, revenue, finance, product packing, logistics, supply chain management, a place of origin, a manufacturing location, an entity description, a supply chain management vendor registered in an international organization procurement system (SCM vendor registration), a capability statement, delivery, corporate history, exclusions, eligibility, conflict of interest, a performance record, litigation, financial standing, social responsibility, and the like, and stores the profile information in the bidding company database 200.

The related profile information about the company may be stored as an evaluation result, which is an arbitrary value, through comparison with a preset evaluation criterion.

The company information may include a company name (current company name, previous company name), an address (domestic address, overseas address), a registration certification, a representative name, a representative criminal record, an executive summary, the establishment year, the number of employees, and an entity type (corporation, sole individual, publicly listed, public entity).

The product information may include core capability and a major product (product HS code, product NAIS, product CVC code, product US code). The major product may include, for example, up to 20 items.

The certifications may include ISO certification, FDA certification, Communaute Europeenne (CE) certification, Korean FDA certification, UL certification, other certifications, and GMP certification. The environmental certification may include green ISO certification.

The ESG compliance may include environmental merit, social merit, and government compliance.

The entity description may include LLC/INC/CO/Trust and Private/Public.

The supply chain management vendor registered in the international organization procurement system (SCM vendor registration) may include SAM, UNGM, UNBD, TED, and MDBs (registration and active code).

The eligibility may include a legal qualification, a criminal record, and bankruptcy.

The conflict of interest may include a history of penalty, the name of an authority to impose a penalty, a penalty type, and a penalty period.

The company information management unit 110 may store the profile information stored in the bidding company database 200 by classifying the profile information according to keywords, HS codes, industrial classifications, and the like.

The company information management unit 110 may receive profile information according to a certain time period or upon separate request, and may manage the profile information to be stored with a change in the information reflected when the change in the information occurs.

The company information management unit 110 may perform input/modification/deletion of service target company information retrieval, industry classification, the type of a provided service, a company status by condition, such as an information collection level, retrieval and counting, and service target company information, input/modification/deletion of information meaningful for industrial classification, the type of a provided service, and a search for other bid notices, and the like.

The bid notice management unit 120 may receive a bid notice including meta information from a buyer connected through a network, and may perform retrieval and management of a unique code system provided by a public procurement site, retrieval and management of a compatibility rule by code and classification system, and the like.

To this end, the bid notice management unit 120 may connect to a buyer terminal 310 and buyer terminal 1 311 to buyer terminal n 312.

Here, a buyer may be a foreign government agency, such as a US agency, an international organization, such as the UN, the UNESCO, the WHO, the OECD, and the EP, or a multilateral development bank, such as the World Bank, the Asian Development Bank, and the African Development Bank.

The bid notice management unit 120 is responsible for a purchasing organization and a sub-organization of each purchasing organization, various business domains (goods/services) provided by the purchasing organization, a date (announcement date or deadline), collection server classification (RSS, OpenAPI, or web scraping), statistics on collected search results, and the like.

The bid notice management unit 120 may include an artificial intelligence-based bid notice search model to receive a bid notice by using robotic process automation (RPA) or an application programming interface (API) at regular time intervals.

That is, the bid notice management unit 120 may access a public procurement bid notice site according to a certain period (24 hours or the like), may collect data by RSS, openAPI, and web scraping according to a method provided by the site, and may store a changed part in the bid notice database 300 by comparing the data with a previously stored existing bid notice.

The bid notice management unit 120 may retrieve and collect bid notice information including both structured data provided by a buyer (or purchasing organization) as a structured object, such as XML or JSON, and unstructured data, such as PDF and Word, accessible through a link provided in a notice.

The structured data may be stored in a table of a predefined relational database management system (RDBMS), and may provide structured information.

The unstructured data may be stored in a file system of a server, and may be structured to be referenced for the relational database management system.

It is possible to identify and extract a main keyword meaningful for a search for a bid notice from the structured data, and to provide a user screen to identify and modify matching of refined content.

In addition, since simultaneous access to a plurality of sites and collection of various unstructured data may cause loads, the bid notice management unit 120 may perform collection by defining an appropriate level, for example, limiting the type of a collectable public procurement site and the type of a document to be downloaded.

The bid notice management unit 120 may be configured as a server system, in which case the bid notice management unit 120 may be configured separately from the relational database management system, and collected data may be backed up in a server of the relational database management system according to a certain period (24 hours or the like).

The bid notice management unit 120 may perform collection and management through a web to manage a collection system operation rule of each public procurement site, a data collection rule and structure required by each public procurement site, and an operation cycle and method for each public procurement site.

Further, the bid notice management unit 120 may perform collection system operation status monitoring and log check, provision of a bid notice DBMS management screen through a web, retrieval of the DBMS and the table and retrieval of a status, provision of a bid notice file system management screen through a web, and identification of information, such as storage server capacity and remaining available capacity.

In addition, the bid notice management unit 120 analyzes received bid notice information by using an unsupervised learning-based artificial intelligence-based bid notice search model, classifies the bid notice information according to general terms and conditions, special terms and conditions, and specifications of a relevant buyer to extract a requirement of a bid notice by each buyer, and manages an extraction result to be stored in the bid notice database 300.

Accordingly, regarding one bid notice, the bid notice management unit 120 may extract comprehensive bidding conditions (or requirements) from general terms terms and conditions, and conditions, special specifications of a relevant buyer in addition to the bid notice.

The bidding conditions (or requirements) may be extracted from words and sentences included in the general terms and conditions, the special terms and conditions, and the specifications of the relevant buyer in addition to the bid notice by using an artificial intelligence-based natural language processing program.

A bid notice by each buyer may include various requirements of minimum eligibility and qualification criteria, technical and financial weights, and technical evaluation criteria.

The suitability analysis unit 130 may classify companies and bid notices, may classify and adjust company characteristic-related profile information by applying an unsupervised learning-based artificial intelligence-based suitability analysis model, and may classify and adjust characteristics, such as meta information and bidding conditions included in a public procurement bid notice.

The suitability analysis unit 130 may extract a list of bid notices to be matched by integrating the profile information by company and the meta information in the bid notice obtained through the bid notice management unit 120 to be mapped in a company-bid notice table.

The suitability analysis unit 130 may extract a bid notice suitable for a company, based on the list of classified bid notices, and may match the bid notice with the company.

That is, the suitability analysis unit 130 may provide a customized bid notice or a list of ranked bid announcement lists recommended for each company along with numerical information, may identify and filter target information and content of the company to gather a result, and may reflect filtered information to be mapped to a company-bid notice in the table.

The suitability analysis unit 130 may perform retrieval and condition-specific lookup of final matching information for each company, for example, a result matched by a company-bid notice, and may generate or convert the final matching information for each company in a distributable form (e.g., including XML and a related UIRL link) to download the same to a file system or the like.

The suitability analysis unit 130 may map one or more company keywords extracted from the profile information by company and one or more words or sentences retrieved corresponding to the company keywords from the bid notice by buyer or meta information by using the artificial intelligence-based suitability analysis model, thereby evaluating the matching suitability of the company for a bidding condition required by the buyer.

That is, when a company keyword, for example, ‘eligibility’, is extracted from the profile information by company that meets an international bidding requirement through the artificial intelligence-based suitability analysis model, the suitability analysis unit 130 extracts a sentence related to ‘eligibility’ from the bidding condition (or requirement) of the bid notice of the buyer in response thereto.

The suitability analysis unit 130 extracts common information between the company and the buyer by matching the related sentence among extracted requirements with specific condition information from the company related to the company keyword of ‘eligibility’.

The suitability analysis unit 130 may extract the common information by matching various company keywords, such as ‘Product Code (Service/Goods/Works)’, ‘Deadline’, ‘Type of Tender’, ‘Content of line item’, ‘Quantity/Unit of line item’, ‘Legal Qualification’, ‘Exclusion’, ‘Delivery requirement’, ‘Duty/Tax’, ‘ Delivery locations’, ‘product certification’, ‘ISO certification’, ‘Green Procurement’, ‘Product Specification’, ‘Product Specification’, ‘Product Specification’, ‘packing’, and ‘Hazard’, in addition to ‘eligibility’ and the requirement of the buyer.

‘Product Code (Service/Goods/Works)’ may include an HS, a UN supply code, an NAICS code, and a CVS.

‘Deadline’ may be subdivided into more than 30 days, less than 30 days, 15 to 30 days, 5 to 14 days, less than 5 days, and the like.

‘Type of Tender’ may be divided into EOI, RFI, RFQ, RFP, ITB, and shopping.

‘Content of line item’ may be subdivided into service/goods/works.

‘Quantity/Unit of line item’ may be subdivided into service/goods/works.

‘Legal Qualification’ may be subdivided into a corporation, a non-profit corporation, and an individual.

‘Exclusion’ may be subdivided into financial exclusion, b bankruptcy, social responsibility, overdue tax/imposition, litigation, and the like.

The suitability analysis unit 130 may calculate matching suitability, based on a matching result, such as ‘Product Code (Service/Goods/Works)’, ‘Deadline’, ‘Type of Tender’, ‘Content of line item’, ‘Quantity/Unit of line item’, and ‘Legal Qualification’, ‘Exclusion’, ‘Delivery requirement’, ‘Duty/Tax’, ‘Delivery locations’, ‘product certification’, ‘ISO certification’, ‘Green Procurement’, ‘Product Specification’, ‘Product Specification’, ‘Product, ‘packing’, and ‘Hazard’.

Matching suitability refers to a value obtained by extracting common information between profile information about a company and an overseas procurement buyer by matching profile information about the company that meets an international bidding requirement and a bidding condition (or requirement) collected from a bid notice including meta information by the buyer, and numerically converting a mapping result based on the extracted common information.

The matching suitability may be calculated by the following equation.

$$E = x ( y 1 + y 2 + y 3 ) \qquad [ Equation 1 ]$$

Here, E is the calculated value of matching suitability; X is an evaluation item of a purchasing organization, which is a constant; as values for a quantified item-specific requirement of the purchasing organization with respect to a company, which are variables, y1 is a standardized value for a requirement of general terms and conditions of a buyer, y2 is a standardized value for a requirement of special terms and conditions of the buyer, and y3 is a standardized value for a requirement of technical specifications of the buyer.

That is, the suitability analysis model of the suitability analysis unit 130 may numerically calculate a result of matching the profile information about the company and the bid notice including the meta information by the buyer by setting evaluation information of the profile information by company, which is an unchanging value, as a constant and setting a requirement, which is a different value for each buyer and each bid notice, as a variable.

The suitability analysis unit 130 may include a learning agent trained to determine optimal interpretation and intention information for a word or sentence used by the artificial intelligence-based suitability analysis model for each buyer.

To this end, the learning agent may include a natural language processing program trained to understand the same word appropriately for each buyer by differentially interpreting even the same word depending on given environments or conditions.

Further, the learning agent may be a language model that learns the context and order of two sentences considering the relationship between the two sentences by predicting whether the second sentence is a sentence immediately following the first sentence when there are the two sentences.

The learning agent according to an embodiment of the disclosure is an artificial intelligence-based suitability analysis model, and may be configured with analysis models generated through a deep learning method in machine learning.

Therefore, the artificial intelligence-based suitability analysis model according to an embodiment of the disclosure may be configured in an expression of a deep learning model or a deep learning analysis model.

Machine learning is an application of artificial intelligence that enables complex a system to automatically learn and improve from experience without being explicitly programmed.

The accuracy and effectiveness of machine learning models may depend partly on data used to train the models.

Therefore, the artificial intelligence-based suitability analysis model according to an embodiment of the disclosure may repeatedly learn, as learning data, a word or sentence selected based on a resulting value of comparing a plurality of pieces of learning data, based on a bid notice by buyer and general terms and conditions, special terms and conditions, and specifications a buyer issuing a bid notice.

Further, the learning agent according to an embodiment of the disclosure may configure an artificial intelligence-based suitability analysis model for each buyer.

Accordingly, the artificial intelligence-based suitability analysis model according to an embodiment of the disclosure may be configured with analysis models for each buyer generated through the deep learning method in machine learning.

For example, the learning agent according to an embodiment of the disclosure may be configured with a plurality of different learning agents for each foreign government agency, such as a US agency, each international organization, such as the UN, the UNESCO, the WHO, the OECD, and the EP, or each multilateral development bank, such as the World Bank, the Asian Development Bank, and the African Development Bank.

For example, the artificial intelligence-based suitability analysis model according to an embodiment of the disclosure may be configured with a plurality of different artificial intelligence-based suitability analysis models for each foreign government agency, such as a US agency, each international organization, such as the UN, the UNESCO, the WHO, the OECD, and the EP, or each multilateral development bank, such as the World Bank, the Asian Development Bank, and the African Development Bank.

The suitability analysis unit 130 may extract the matching suitability of the company evaluated based on the common information analyzed through mapping of the profile information by company and the requirement of the buyer and an optimal bid notice the most suitable for the company.

The suitability analysis unit 130 may match the extracted optimal bid notice with the company, and may transmit the same to a terminal of the company among the terminal 210 of the company and company terminal 1 211 to company terminal n 212.

The suitability analysis unit 130 may also generate and output one or more reports among a company analysis report, a product analysis report, a financial analysis report, a bidding environment report, and company capability report, based on the profile information by company stored in the bidding company database 200.

That is, the suitability analysis unit 130 may output the reports such that the terminal 210 of the company and company terminal 1 211 to company terminal n 212 may be connected through a smartphone, a smart device (tablet), or the like to retrieve key information on an optimized screen.

The bidding company database 200 stores company profile information including company analysis information, product analysis information, financial analysis information, bidding environment information, and company capability information by company.

The bidding company database 200 may store the company analysis information, the product analysis information, the financial analysis information, the bidding environment information, and the company capability information by dividing the same into preset representative items and detailed items subordinate to the representative items.

The bidding company database 200 may store a representative value, a code value, or an evaluation value for each item by each divided item.

The bidding company database 200 may store information obtained through notice and news information, company information, and various types of service support for each item.

The bid notice database 300 may classify a bid notice including meta information by each buyer and a bid condition, based on the bid notice and the meta information, and may store an analysis result of classification and code information, based on the classified bid condition.

The bid notice database 300 may include a code and a classification system generally used in the system by utilizing a keyword, an HS code, and an industry classification that are useful for searching for a bid notice.

The bid notice database 300 may store international and association codes and pieces of information that meet a bidding condition related to a bid notice.

The bid notice database 300 is capable of accepting and expanding compatibility, redundancy, and possibility of matching between stored codes, and a newly assigned code system and classification rule.

The bidding company database 200 and the bid notice database 300 may store the name and format of data according to a database management standard, and may store standardization information for data sharing and reuse, data exchange, data quality improvement, and database integration.

Further, the bidding company database 200 and the bid notice database 300 may perform a matching check, log recording, and back-up of data when encrypting and decrypting a database including private data and uploading/updating data.

In addition, the bidding company database 200 and the bid notice database 300 may be organically structured by reflecting a related business processing procedure to accept data standardization, data management, and standard terminology.

Furthermore, to efficiently operate and manage the database and prevent unnecessary waste of a space, duplication of tables and columns may be minimized, and joint use of each function may be possible.

Hereinafter, an artificial intelligence and machine learning-based overseas public procurement customized bidding information provision service method according to an embodiment of the disclosure is described.

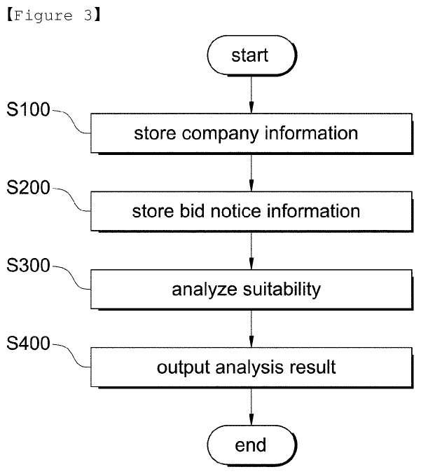

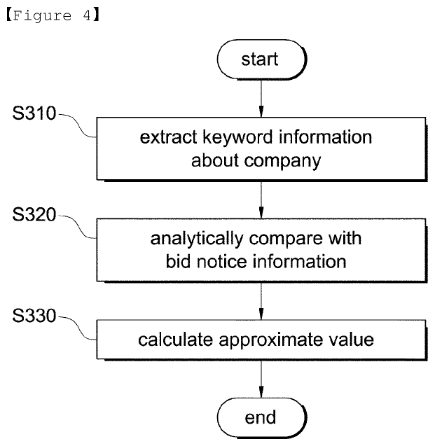

FIG. 3 is a flowchart illustrating an artificial intelligence and machine learning-based overseas public procurement customized bidding information provision service method according to an embodiment of the disclosure, and FIG. 4 is a flowchart illustrating a suitability analysis process of the artificial intelligence and machine learning-based overseas public procurement customized bidding information provision service method according to the embodiment of FIG. 3.

Referring to FIG. 1 to FIG. 4, in the artificial intelligence and machine learning-based overseas public procurement customized bidding information provision service method according to the embodiment of the disclosure, the suitability analysis server 100 stores profile information by company including one or more of analysis information, product analysis company information, financial analysis information, bidding environment information, and company capability information collected by company in the bidding company database 200 (S100).

The suitability analysis server 100 receives a bid notice including meta information from the buyer terminal 310 and buyer terminal 1 311 to buyer terminal n 312 connected through a network, analyzes the collected bid notice to divide the bid notice into general terms and conditions, special terms and conditions, and specifications, and classifies the divided bid notice by buyer to store the bid notice in the bid notice database 300 (S200).

The suitability analysis server 100 maps and compares the profile information by company stored in the bidding company database 200 and the bid notice including the meta information by buyer stored in the bid notice database 300, and extracts an optimal bid notice suitable for a company by analyzing and evaluating matching suitability according to a comparison result (S300).

In operation S300, the suitability analysis server 100 extracts one or more company keywords from profile information about a company meeting an international bidding requirement stored in the bidding company database 200 by using the artificial intelligence-based suitability analysis model (S310).

Further, the suitability analysis server 100 evaluates the matching suitability of the company by matching one or more words or sentences, retrieved corresponding to the company keywords extracted from the bidding company data 200 from one or more bid notices suitable for the company by comparing the meta information of the bid notice by buyer stored in the bid notice database 300, with the company keywords and comparatively analyzing the words or sentences and a bidding condition (or requirement) required by the buyer (S320).

That is, in operation S320, the suitability analysis server 100 extracts common information between the company and the buyer by mapping a word or sentence extracted from the bidding condition (or requirement) of the buyer in the bid notice database 300 corresponding to the company keywords extracted from the profile information in the bidding company database 200, for example, a requirement such as ‘delivery within 30 days from now’ and ‘environmentally certified product’, onto detailed information about the company related to the company keywords, for example, information such as ‘product production capacity’ and ‘company capability’.

The suitability analysis server 100 may calculate the matching suitability, based on the mapping result, and the calculated value may be obtained by the following equation.

$$E = x ( y 1 + y 2 + y 3 ) \qquad [ Equation 2 ]$$

Here, E is the calculated value of matching suitability; x is an evaluation item of a purchasing organization, which is a constant; as values for a quantified item-specific requirement of the purchasing organization with respect to a company, which are variables, y1 is a standardized value for a requirement of general terms and conditions of a buyer, y2 is a standardized value for a requirement of special terms and conditions of the buyer, and y3 is a standardized value for a requirement of technical specifications of the buyer.

In operation S320, the suitability analysis server 100 may extract a bidding condition (or requirement) by buyer matched using a learning agent that is trained to interpretation and intention determine optimal information for a word or sentence used by each buyer.

The learning agent may be a natural language processing-based language model trained to understand the same word appropriately for each buyer, for example, by differentially interpreting the word depending on given environments or conditions, or that learns the context and order of two sentences considering the relationship between the two sentences.

The suitability analysis server 100 extracts the optimal bid notice suitable for the company information, based on the calculated value of the evaluated matching suitability (S330).

The suitability analysis server 100 may calculate only the matching suitability of a separate company for a specific international organization, or may calculate all matching suitability for a plurality of international organizations.

The suitability analysis server 100 may output ranked bid notices as numerical values, based on the result of evaluating the matching suitability.

The suitability analysis server 100 transmits the optimal bid notice suitable for the company extracted in operation S330 to a relevant company terminal among the company terminal 210 and company terminal 1 211 to company terminal n 212 (S400).

Accordingly, profile information by company that meets an international bidding requirement and bid information including meta information collected from procurement information from an overseas procurement buyer may be mapped using an artificial intelligence-based suitability analysis model, and optimal bid information the most suitable for a company may be provided based on matching suitability evaluated through mapping, thereby increasing overseas procurement participation of the company in a public procurement project of an overseas purchasing organization and the overseas procurement success rate of the company.

Further, each company may be provided with a bid notice suitable for the company, and a bid notice may be provided based on bid notices of various buyers and characteristics of separate companies, thereby increasing the bid success rate of the company.

In addition, requirements of international public procurement markets for an industry to which a company belongs or products may be identified, thus being used for improvement in product functions to meet market demand.

Although the disclosure has been described above with reference to exemplary embodiments, it will be understood by those skilled in the art that various changes and modifications may be made without departing from the spirit and scope of the disclosure specified in the following claims.

Reference numerals used in the claims of the disclosure are provided for the clarity and convenience of a description only and not for the purpose of limiting the disclosure, and the thickness of lines or size of components shown in the drawings may be exaggerated for the purpose of convenience and clarity of a description of the embodiments.

Terms used herein are defined in consideration of functions in the disclosure, and may be changed according to the custom or intention of a user or operator. Thus, the definition of such terms should be determined according to overall disclosures set forth herein.

Although not illustrated or described explicitly, it will be apparent to those skilled in the art to which the disclosure pertains that various types of modifications including the technical idea of the disclosure may be made from the description the disclosure, and these modifications also belongs to the scope of the claims of the disclosure.

The foregoing embodiments described with reference to the accompanying claims are provided for the purpose of describing the disclosure, and the scope of the claims of the disclosure is not limited thereto.

### DESCRIPTION OF REFERENCE NUMERALS

100: Suitability analysis server
110: Company information management unit
120: Bid notice management unit
130: Suitability analysis unit
200: Bidding company database
210: Company terminal
211: Company terminal 1
212: Company terminal n
300: Bid notice database
310: Buyer terminal
311: Buyer terminal 1
312: Buyer terminal n

1. An artificial intelligence and machine learning-based overseas public procurement customized bidding information provision service system comprising:
a suitability analysis server (100) configured to match one or more bid notices, extracted by comparing profile information by company that meets an international bidding requirement stored in a bidding company database (200) with meta information of a bid notice by buyer stored in a bid notice database (300), with a corresponding company by using an artificial intelligence-based suitability analysis model, to convert an evaluation item of a buyer, a requirement of general terms and conditions of the buyer, a requirement of special terms and conditions of the buyer, and a requirement of technical specifications of the buyer that are included in the bid notice of the buyer into a quantized value corresponding to a requirement by item, based on common information between the profile information and the meta information, to evaluate matching suitability through calculation of the quantized value for the converted evaluation item and the requirement by item, and to extract an optimal bid notice in which a calculated value of the matching suitability has a highest matching value,
wherein the calculated value of the matching suitability is calculated by the following equation:
$$E = x ( y 1 + y 2 + y 3 ) ,$$
where E is the calculated value of the matching suitability; x is an evaluation item of a purchasing organization, which is a constant; as values for a quantified item-specific requirement of the purchasing organization with respect to the company, which are variables, y1 is a standardized value for the requirement of the general terms and conditions of the buyer, y2 is a standardized value for the requirement of the special terms and conditions of the buyer, and y3 is a standardized value for the requirement of the technical specifications of the buyer.

2. The artificial intelligence and machine learning-based overseas public procurement customized bidding information provision service system of claim 1, wherein the suitability analysis server (100) comprises:
a company information management unit (110) configured to manage company analysis information, product analysis information, financial analysis information, bidding environment information, and company capability information about each company provided from a company;
a bid notice management unit (120) configured to receive bid notice information by connecting to one or more buyer terminals (310, 311, and 312) and to manage the bid notice information by buyer by dividing the received bid notice information into general terms and conditions, special terms and conditions, and specifications; and
a suitability analysis unit (130) configured to analyze and evaluate the matching suitability for a bidding condition required by the buyer by mapping one or more company keywords extracted from the profile information by using the artificial intelligence-based suitability analysis model onto one or more words or sentences retrieved from the bid notice by buyer corresponding to the company keywords, to extract the optimal bid notice having the highest matching value, based on the calculated value of the evaluated matching suitability, and to transmit the extracted bid notice to company terminals (210, 211, and 212) by matching the extracted bid notice to the corresponding company.

3. The artificial intelligence and machine learning-based overseas public procurement customized bidding information provision service system of claim 2, wherein the suitability analysis unit (130) extracts the bid notice having the highest matching value, based on the matching suitability based on the common information between the profile information and the meta information by mapping the profile information by company to the meta information of the bid notice collected by the bid notice management unit (120).

4. The artificial intelligence and machine learning-based overseas public procurement customized bidding information provision service system of claim 3, wherein the suitability analysis unit (130) transmits the one or more extracted bid notices, along with numerical information, to the company terminals (210, 211, and 212).

5. The artificial intelligence and machine learning-based overseas public procurement customized bidding information provision service system of claim 2, wherein the suitability analysis unit (130) comprises a learning agent, and
the learning agent is trained to determine optimal interpretation and intention information for a word or sentence used by the artificial intelligence-based suitability analysis model for each buyer.

6. The artificial intelligence and machine learning-based overseas public procurement customized bidding information provision service system of claim 1, wherein the bidding company database (200) stores the profile information comprising one or more of company analysis information, product analysis information, financial analysis information, bidding environment information, and company capability information about each company.

7. The artificial intelligence and machine learning-based overseas public procurement customized bidding information provision service system of claim 1, wherein the bid notice database (300) stores the bid notice by buyer and the meta information comprising a bidding condition based on the bid notice.

8. The artificial intelligence and machine learning-based overseas public procurement customized bidding information provision service system of claim 1, wherein the artificial intelligence-based suitability analysis model evaluates the matching suitability, based on a requirement of minimum eligibility and qualification criteria included in the bid notice.

9. The artificial intelligence and machine learning-based overseas public procurement customized bidding information provision service system of claim 8, wherein the artificial intelligence-based suitability analysis model evaluates the matching suitability, based on technical and financial weights and a requirement of technical evaluation criteria included in the bid notice.

10. The artificial intelligence and machine learning-based overseas public procurement customized bidding information provision service system of claim 8, wherein the artificial intelligence-based suitability analysis model extracts ‘eligibility’ as a company keyword from the profile information by company that meets the international bidding requirement, extracts a sentence related to ‘eligibility’ from the requirements of the bid notice of the buyer, and extracts the common information between the company and the buyer by matching the related sentence extracted from the requirements with detailed condition information about the company related to the company keyword of ‘eligibility’.

11. An artificial intelligence machine learning-based overseas public procurement customized bidding information provision service method comprising:
operation a) in which a suitability analysis server (100) matches one or more bid notices, extracted by comparing profile information by company that meets an international bidding requirement stored in a bidding company database (200) with meta information of a bid notice by buyer stored in a bid notice database (300), with a corresponding company by using an artificial intelligence-based suitability analysis model, converts an evaluation item of a buyer, a requirement of general terms and conditions of the buyer, a requirement of special terms and conditions of the buyer, and a requirement of technical specifications of the buyer that are included in the bid notice of the buyer into a quantized value corresponding to a requirement by item, based on common information between the profile information and the meta information, evaluates matching suitability through calculation of the quantized value for the converted evaluation item and the requirement by item, and extracts an optimal bid notice in which a calculated value of the matching suitability has a highest matching value; and
operation b) in which the suitability analysis server (100) transmits the extracted bid notices to company terminals (210, 211, and 212) by company,
wherein the calculated value of the matching suitability is calculated by the following equation:
$$E = x ( y 1 + y 2 + y 3 ) ,$$
where E is the calculated value of the matching suitability; x is an evaluation item of a purchasing organization, which is a constant; as values for a quantified item-specific requirement of the purchasing organization with respect to the company, which are variables, y1 is a standardized value for the requirement of the general terms and conditions of the buyer, y2 is a standardized value for the requirement of the special terms and conditions of the buyer, and y3 is a standardized value for the requirement of the technical specifications of the buyer.

12. The artificial intelligence and machine learning-based overseas public procurement customized bidding information provision service method of claim 11, wherein the operation a) comprises:
operation a-1) in which the suitability analysis server (100) extracts one or more company keywords from the profile information by using the artificial intelligence-based suitability analysis model;
operation a-2) in which the suitability analysis server (100) evaluates the matching suitability for a bidding condition required by the buyer by mapping one or more words or sentences retrieved from the bid notice by buyer onto the one or more extracted company keywords; and
operation a-3) in which the suitability analysis server (100) extracts the optimal bid notice having the highest matching value, based on the calculated value of the evaluated matching suitability.

13. The artificial intelligence and machine learning-based overseas public procurement customized bidding information provision service method of claim 12, wherein in the operation a-2), the suitability analysis server (100) retrieves a used word or sentence by using a learning agent trained to determine optimal interpretation and intention information for each buyer.

14. The artificial intelligence and machine learning-based overseas public procurement customized bidding information provision service method of claim 11, further comprising:
operation a′) in which the suitability analysis server (100) stores the profile information comprising one or more of company analysis information, product analysis information, financial analysis information, bidding environment information, and company capability information collected by company in the bidding company database (200).

15. The artificial intelligence and machine learning-based overseas public procurement customized bidding information provision service method of claim 11, further comprising:
operation a″) in which the suitability analysis server (100) stores the bid notice comprising the meta information collected from one or more buyer terminals (310, 311, and 312) and the bid notice by buyer by dividing the bid notice into general terms and conditions, special terms and conditions, and specifications in the bid notice database (300).

16. The artificial intelligence and machine learning-based overseas public procurement customized bidding information provision service method of claim 11, wherein the artificial intelligence-based suitability analysis model evaluates the matching suitability, based on a requirement of minimum eligibility and qualification criteria included in the bid notice.

17. The artificial intelligence and machine learning-based overseas public procurement customized bidding information provision service method of claim 16, wherein the artificial intelligence-based suitability analysis model extracts ‘eligibility’ as a company keyword from the profile information by company that meets the international bidding requirement, extracts a sentence related to ‘eligibility’ from the requirements of the bid notice of the buyer, and extracts the common information between the company and the buyer by matching the related sentence extracted from the requirements with detailed condition information about the company related to the company keyword of ‘eligibility’.
